(19) United States
(12) Patent Application Publication
(10) Pub. No.: US 2012/0152644 A1
(43) Pub. Date: Jun. 21, 2012

(54) Compliant, balanced belt or chain drive

(76) Inventor: Paul Harriman Kydd, Lawrenceville, NJ (US)

(21) Appl. No.: 13/374,260

(22) Filed: Dec. 19, 2011

Related U.S. Application Data
(60) Provisional application No. 61/459,883, filed on Dec. 20, 2010.

(51) Int. Cl. F16H 7/12; B60K 17/08; F16H 7/08

(52) U.S. Cl. 180/366; 474/101; 474/113; 474/111; 474/110; 903/902

(57) ABSTRACT

An improved drive assembly is described which can apply a pure torque to a driven member while allowing for limited motion of the driven member in the radial direction. This drive assembly is particularly suitable for converting an Internal Combustion (IC) vehicle to an IC-electric hybrid vehicle comprising installation of one or two electric motors coupled to a drive shaft of the vehicle via the drive of this invention such that the electric motor can provide some or all of the mechanical power required to propel the vehicle while accepting some relative motion between the existing vehicle drive shaft and the motors. The improvement consists of interlocked idler rollers mounted so as to reduce dynamic loads on the drive at high speeds, thus reducing noise and vibration.

### CROSS-REFERENCE TO RELATED APPLICATIONS

This application claims the benefit of U.S. Patent “Electric Hybrid Vehicle Conversion” U.S. Pat. No. 7,681,676 B2, Mar. 23, 2010, U.S. Patent Application “Electric Hybrid Vehicle Conversion with Balanced Belt or Chain Drive” Appl. No. 20090000836 filed on Jun. 27, 2008, Published on Jan. 1, 2009, Provisional Patent Application “Improved Balanced Belt or Chain Drive for Electric Hybrid Vehicle Conversion” 61/217,104, filed May 27, 2009, and Provisional Patent Application “Electric Hybrid Vehicle Conversion with Improved Balanced Belt or Chain Drive”, 61/396,750, filed Jun. 2, 2010, all by the present inventor. In particular this application claims the priority of Provisional Patent Application 61/459,883 filed Dec. 20, 2010 by the present inventor.

### FEDERALLY SPONSORED RESEARCH

None

### Cited Literature

None

### BACKGROUND OF THE INVENTION

This invention is broadly applicable to driving a rotating shaft which must be allowed to move radially to accommodate vibration and motion relative to fixed surroundings. It has particular utility as it relates to a hybrid internal combustion-electric drive system for a vehicle, and specifically to such a drive system that is retrofittable to existing internal combustion engine vehicles. The drive system includes a speed reduction system that enables one or more standard electric motors to propel the vehicle either alone or in combination with an Internal Combustion (IC) engine. The speed reduction system is a balanced belt or chain drive mounted to the chassis of the vehicle which applies a pure torque to the drive shaft of the vehicle.

U.S. Pat. No. 7,681,676, Mar. 23, 2010, “Electric Hybrid Vehicle Conversion” by the present inventor disclosed an electric motor mounted on the chassis of a vehicle and driving the drive shaft of the vehicle by a flexible drive means such as a toothed timing belt or a chain.

The most convenient point for the application of an electric belt or chain drive to many vehicles is the forward universal joint of the drive shaft which exhibits minimum (though still appreciable) motion relative to the fixed chassis of the vehicle. Unfortunately this joint is frequently relatively inaccessible for the mounting of a drive pulley and driving motor, and it is supported by a simple bushing at the output end of the transmission shaft extension, which is incapable of sustaining the radial tension required to avoid slippage and skipping of the drive belt or chain.

Patent Application US20090000836, Jun. 27, 2008, “Balanced Belt or Chain Drive for Electric Hybrid Vehicle Conversion” disclosed several drive configurations which will apply a pure torque to the drive shaft while allowing it to move slightly in both radial directions to accommodate the motion of the IC engine-transmission unit in its flexible mounts. The drive allows for a significant tensioning force to prevent slipping of the belt or chain without displacing the driven member by application of significant radial force as occurs in a single belt drive.

Provisional Patent Applications 61/217,104 filed on May 27, 2009, 61/396,750 filed on Jun. 2, 2010, and 61/459,883 filed Dec. 20, 2010, disclose additional means to achieve the same goal while providing for better dynamic isolation of vibration of the driven sprocket.

The same requirement is met with two-part drive shafts because the center bearing is flexibly mounted to allow for vibration and motion of the two halves of the shaft. Again, the most convenient location for the hybrid drive is often the forward universal joint of either the first or the final drive shaft, but any location along the forward drive shaft is isolated from the excursions caused by the suspension moving up and down over road irregularities, and can be utilized to attach the hybrid drive.

This present application discloses means for providing a pure torque to a driven shaft while allowing it to move freely in the radial direction and providing still better dynamic isolation, which has proven particularly satisfactory in actual service on a hybrid vehicle conversion beginning on Nov. 22, 2010.

### BRIEF SUMMARY OF THE INVENTION

This invention comprises an improved balanced belt or chain drive, consisting of one or more driven pulleys or sprockets mounted on an output shaft, which are driven by belts or chains such that all the forces on the driven member are balanced except for torque. Two or more driving means engage the belts or chains via drive pulleys or sprockets in such a way that they apply tensioning forces to the belt or chain, which offset one another, and driving forces which combine with one another to provide torque to the driven member. The improvement of this present invention consists in providing pairs of interlinked idlers to tension driving belts or chains on each side of the driven sprockets which can move in unison to permit radial motion of the driven sprockets while applying a torque to them in either direction. This is an extension of the concept disclosed in FIG. 5 of Provisional Patent Application 61/396,750 (FIG. 2 of the present application), which shows a similar drive with only one set of interlinked idler sprockets.

In Patent Application US20090000836 two driving motors were shown located on each side of the output shaft, which is a convenient layout. It was shown that vertical vibrations of the drive shaft are easily accommodated by vertical excursions of the driving belt or chain and slight rotation relative to one another of the driving pulleys. The static force required to accomplish this is low due to the small change in angle of the belt relative to the driven pulley and the resulting small restoring force, even with considerable belt tension.

Vibrations in the horizontal plane are more difficult to accommodate because the belt or chain is locked to the driven pulley in the direction of the driving motor and the entire motor must move to accommodate motions in this direction. Again static motions can be accommodated by allowing both motors to sway sidewise as shown in FIGS. 2 and 4 of Application US20090000836, but the dynamic response is worse than in the vertical direction because the entire mass of both motors is required to move to accommodate vibrations. As claimed in Application 20090000836 the drive pulleys can be driven remotely, as by long flexible shafts from the motors, thereby reducing the mass to that of the drive pulleys and their supporting bearings.

It is an objective of the present invention to reduce the radial dynamic forces on the driven pulley of the drive shown in Application US20090000836. It is a further objective of this invention to enable the use of the hybrid drive method disclosed in U.S. Pat. No. 7,681,676, and Application US20090000836 in vehicles of almost any type having rear-wheel or all-wheel drive in a particularly convenient configuration. It is a further objective of this invention to provide maximum compliance of the drive in the radial direction and minimum coupling of the electric motors to the driven sprocket to minimize vibrations and noise associated with the drive. It is a final objective of this invention to provide for a drive which can apply torque to a driven sprocket in either direction so that a vehicle for example so driven may be operated in reverse or provide regenerative braking by driving the electric motors as generators and extracting energy from the moving vehicle.

### BRIEF DESCRIPTION OF THE DRAWINGS

The means by which these objectives are achieved by the present invention are illustrated in the accompanying drawings:

FIG. 1 is a schematic plan view of the major mechanical components of the drive system of this invention applied to a vehicle with a single drive shaft and two motors looking downwards from above.

FIG. 2 is a copy of FIG. 5 in Provisional Patent Application 61/396,750, which is a schematic elevation showing two interlinked idlers tensioning a balanced belt or chain allowing two motors to drive a single sprocket without imposing unbalanced radial forces on it while allowing it to move radially to accommodate vibration and relative motion of the driven sprocket.

FIGS. 3a and b are schematic elevations of alternative embodiments of this present invention with pairs of idlers either pinching in or expanding out the driving belts or chains in the radial direction which are interlinked by tensioning cables such that their positions are not affected by applied torque.

FIGS. 4a and 4b are a schematic plan and elevation showing the balanced driving means disclosed in this present invention applied to drive a shaft from a single motor.

FIG. 5 is a schematic plan view showing means for driving the assembly remotely with a long drive shaft.

FIG. 6 is a schematic plan view showing the means of this invention applied to a two-part drive shaft.

### DETAILED DESCRIPTION OF THE INVENTION. THE PREFERRED EMBODIMENT

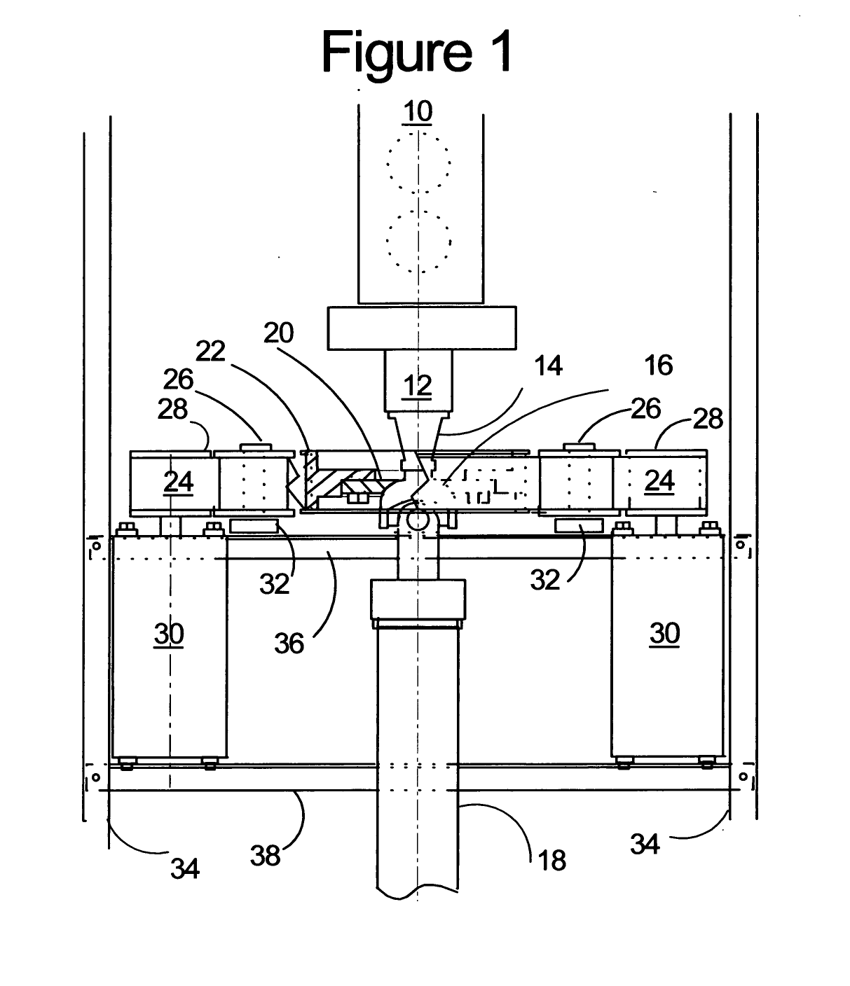

FIG. 1 schematically illustrates the mechanical components of the hybrid drive system in which an internal combustion engine 10 with transmission 12 has an output shaft extension 14 supporting an internal output shaft (not shown) which is typically coupled to universal joint 16 by a spline joint. The universal joint drives drive shaft 18 to propel the vehicle.

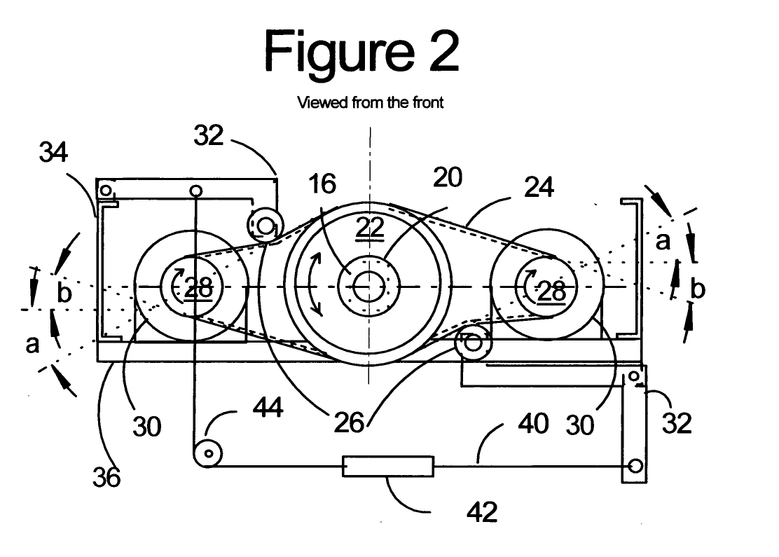

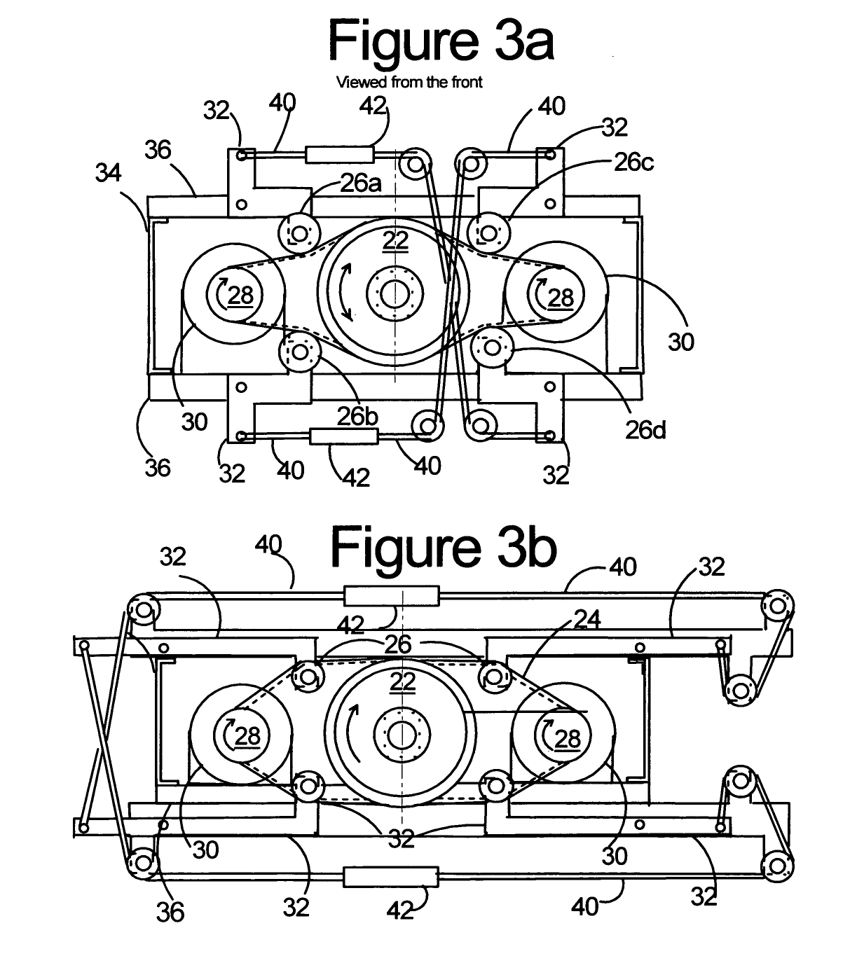

FIG. 1 in plan view from above is cut away on the left to show the internal construction. Disc 20 is fixed to the transmission side yoke of universal joint 16, or to the center of an integral vibration dampener ring on the yoke. Driven pulley or sprocket 22 is bolted to disc 20. Cross members 36 and 38 support motors 30 which have driving pulleys or sprockets 28 which drive pulley or sprocket 22 by means of belt or chain 24. Belt or chain 24 may be a single long chain with lobes on either side as shown in FIGS. 1 and 2 or it may be two separate chains, one for each side, as required by the embodiment shown in FIG. 3b.

As shown in FIG. 2 idler rollers 26 are mounted on levers 32 to tension the belts or chains. Cable 40 interlinks opposite levers 32 via turnbuckle 42 to adjust the tension. When motors 30 are not energized, the tension in the belt or chain is everywhere equal, and if angles a and b are equal, there is no net force on sprocket 22. Sprocket 22 is however free to move slightly vertically by virtue of slight relative rotation of sprockets 28. Sprocket 22 is also free to move horizontally by virtue of the interlinking cable 40 running over pulley 44 which maintains tension on the idlers but allows one to move in and the other to move out by a compensating amount. Operation of motors 30 in the direction shown applies a tensile force to each of the straight portions of belt or chain 24 which provides a pure torque to sprocket 22 without affecting the balanced forces due to tensioning of idlers 26. The torque can be applied in the reverse direction, or sprockets 28 can drive sprocket 22 for regenerative braking, and the driving tension in the belt or chain is supported by interlinked idlers 26 which are prevented from both moving out and loosening the belt or chain by interconnecting cable 40.

It has been found in practice that the drive shown schematically in FIG. 2 is not sufficiently compliant to isolate vibrations in the sprocket 22 from the vehicle. The straight sections of chain provide an undesirably rigid connection between sprocket 22 and sprockets 28. The solution to this problem has been to employ an extra set of idlers which provide additional compliance and vibration isolation without compromising the ability to provide a pure torque to sprocket 22 in either direction.

FIGS. 3a and 3b show schematically how motors 30 and sprockets 28 drive sprocket 22 via belt(s) or chain(s) 24 tensioned by interlinked idlers 26. Levers 32 are pinned to cross members 36 which are attached to the frame rails 34 of the vehicle. Tensioner cables 40 with adjustable turnbuckles 42 exert a force to tension belt or chain 24 and prevent slippage, while providing adjustment to prevent over tension and to allow for wear and stretch of the belt 24. The combination of levers 32 and tensioner cables 40 allows the belt or chain to be tensioned properly regardless of the exact horizontal position of pulley or sprocket 22 and accommodates vibrations of sprocket 22. If 22 moves to the left, the rightward idlers 26 c,d open up to accommodate the motion and the leftward idlers 26 a,b move in by a nearly equal amount to maintain the proper belt tension, and vice versa. If motors 30 are providing torque and tensioning the belt unequally, the interlinked idlers 26 b,c resist the torque and idlers 26 a,d maintain belt tension. If the motors reverse, or if they are driven as generators by sprocket 22, the idler functions are reversed, but the ability of the assembly to provide a pure torque in either direction while allowing for relative motion of sprocket 22 and the frame of the vehicle is maintained.

It is an essential feature of this invention that the driven sprocket 22 is driven from both sides by a balanced set of forces generated by a continuous belt or chain or in the case of outwardly moving idlers in FIG. 3b by two separate belts or chains. It is an additional requirement that the belt or chain be maintained in proper tension, but that it allow for movement radially in all directions of driven sprocket 22. It is a further requirement that the belt or chain transmit torque to the driven sprocket, preferably in either direction, without exerting a radial force upon it. The assemblies shown in FIGS. 3 a and b accomplish all of these objectives.

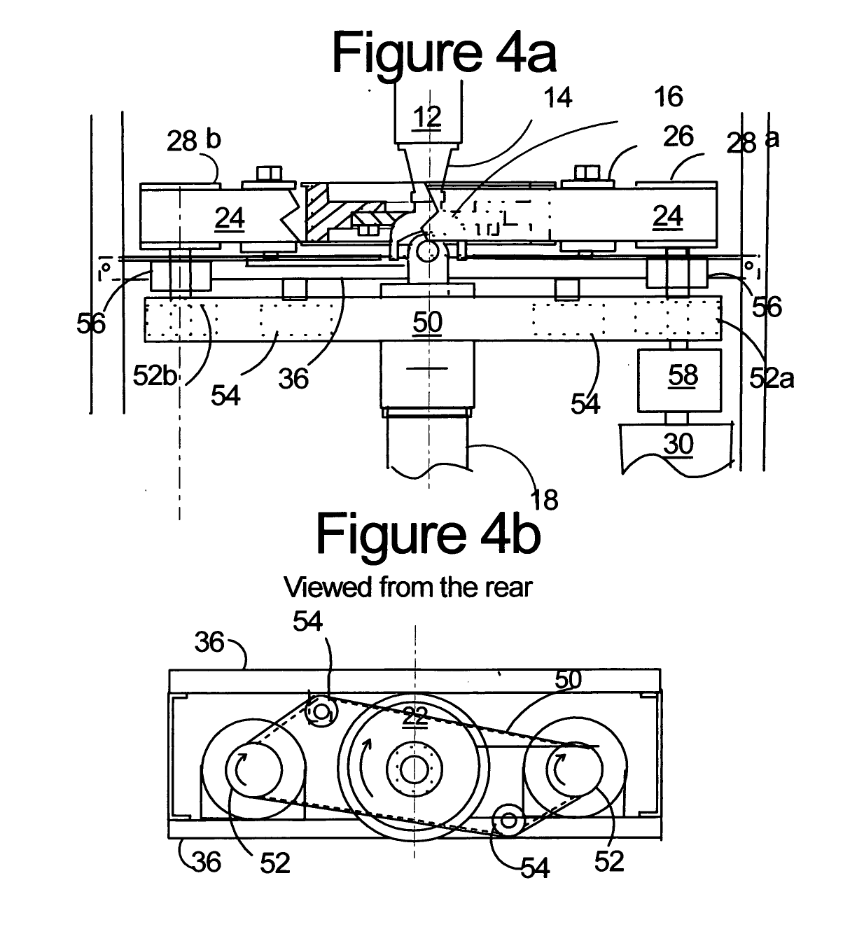

FIG. 4A is a plan view of a similar installation with a single motor 30. In this case a cross belt or chain 50 is used to transmit torque from motor 30 to driving sprocket 28b via sprocket 52b equal to the torque transmitted directly to sprocket 28a through sprocket 52a to achieve the balanced driving force necessary to the requirements of this application. Belt or chain 50 is tensioned by idler sprockets 54 which unlike idler sprockets 26 are rigidly mounted to the frame of the vehicle via cross members 36 to provide a rigid connection between sprockets 52a and 52b. Independent adjustment of the positions of idler sprockets 54 allows for synchronizing the angular engagement of chains 50 and 24, each of which is rigidly locked to the shaft of motor 30. Idler sprockets 54 may be equipped with devices such as spring-loaded cams or spring-loaded overrunning clutches to allow for automatic adjustment to accommodate wear or stretch of the belt or chain 50 while maintaining rigid support of the idlers to allow for torque transmission in either direction. Windmilling of the electric motor 30 when operating on IC power only can be prevented by installing clutch 58, which can be mechanically, hydraulically or, electrically operated.

Alternatively, the interconnection between sprockets 52 and sprockets 28 may include overrunning clutches 56 to prevent windmilling and to permit sprockets 28 to be automatically locked together in the proper angular relationship to match the interlinking of the belts or chains to sprocket(s) 22. In this case idler sprockets 54 are unnecessary to adjust sprockets 52 and 28, but torque can be transmitted in only one direction. Belt or chain 50 can be tensioned by moving the entire assembly 28 b, 52 b or by a single idler sprocket.

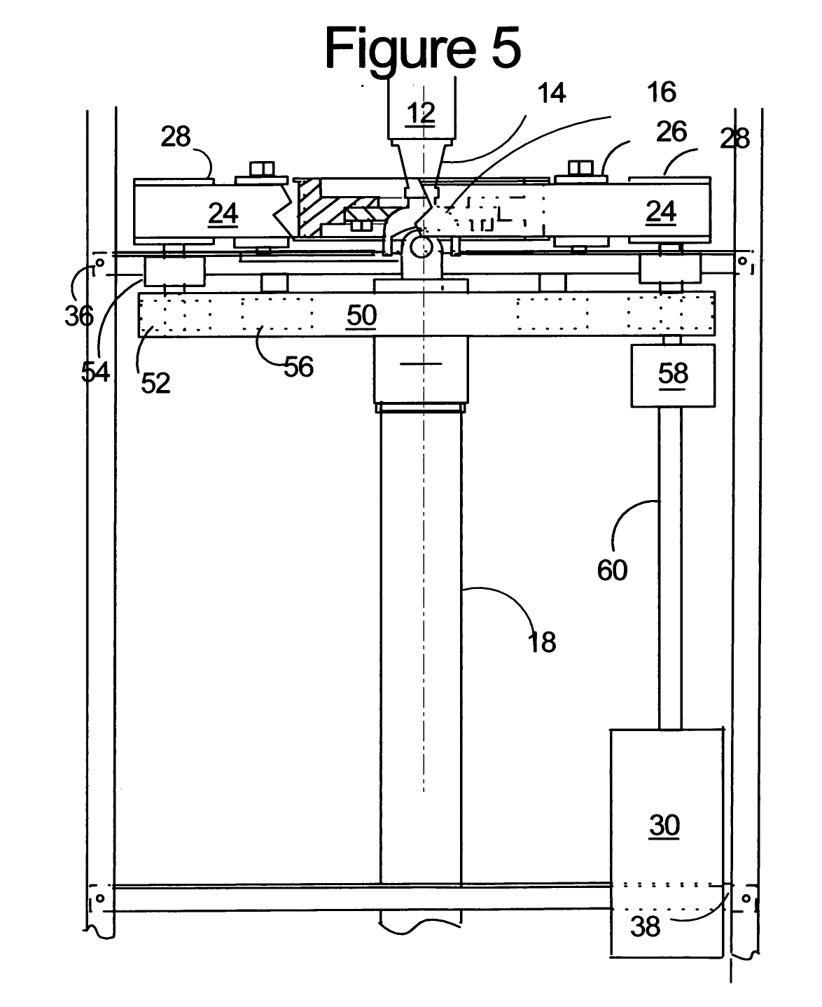

In FIG. 5 motor 30 is mounted remotely to accommodate the existing structure of the vehicle in which it is employed and sprockets 28 are driven by an extended driveshaft 60, through clutch 58, if fitted. The extended drive shaft may be rigid or flexible. It might also consist of yet another belt of chain drive as appropriate to the space available in the installation.

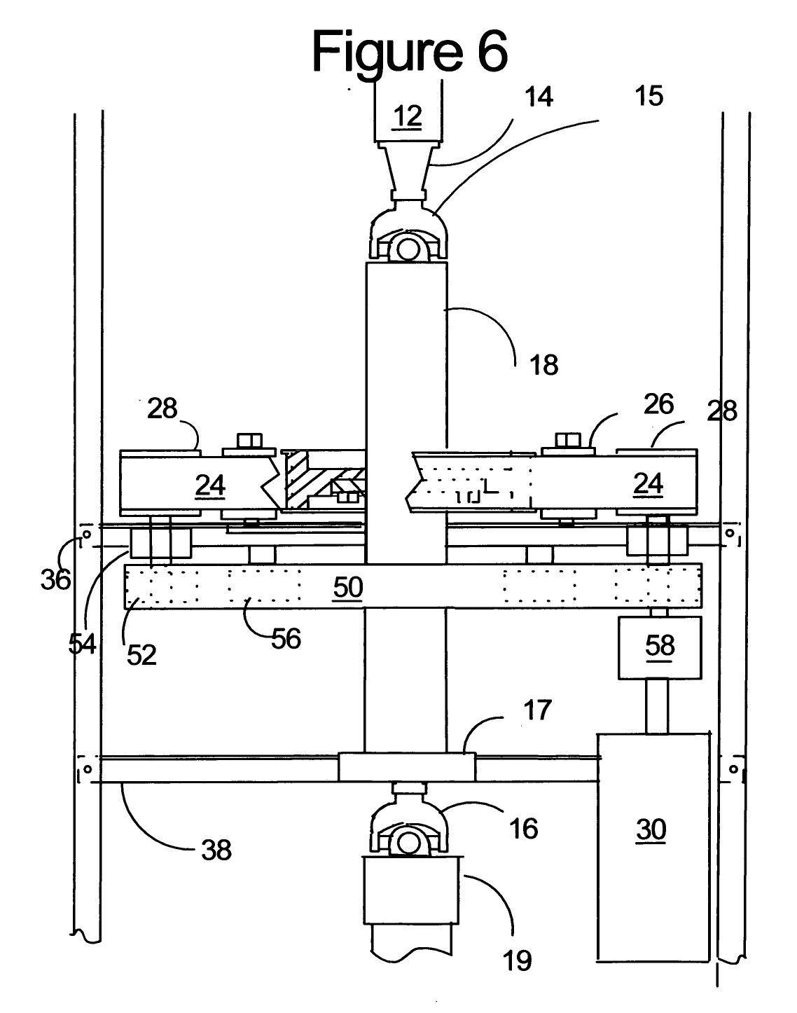

Similarly the means shown in FIGS. 3 a,b or 4 a,b can be mounted at a convenient point along the forward section of a two-part drive shaft where the motion of the shaft relative to the vehicle is minimal, as shown in FIG. 6. Here the drive of this invention is mounted halfway along forward drive shaft 18 between front universal joint 15 and intermediate bearing 17. It could equally well be mounted on rear universal joint 16 driving rear drive shaft 19 as an early version of this invention was. Any location along the front drive shaft is acceptable, depending on the space available in a particular vehicle.

### Other Embodiments

Motor(s) 30 may be either variable speed AC or DC electric motors, preferably of adequate power to propel the vehicle at highway speeds, for example the FB1-4009 9 inch diameter series wound DC motor from Advanced DC Motors, Inc. Syracuse, N.Y. The belt drive of this invention provides speed reduction between the electric motor(s) and the drive shaft of the vehicle to match the motor to the requirements of the vehicle and allow physically smaller motors to provide the requisite torque. Typically the shaft will run at approximately 3000 rpm at a vehicle speed of 65 mph, while the electric motors will run at approximately 5000 rpm. Any other prime movers can be used as motors 30, for example hydraulic motors, pneumatic motors, steam engines both reciprocating and turbine, and internal combustion engines, both reciprocating and turbine.

The flexible speed reducer of this invention may be of any type that provides the desired torque and power capability to match the requirements of the vehicle to motors 30. It is shown as a Poly Chain drive, which is desirable for silent operation in the dirty and wet environment under the vehicle.

### Example 1

The drive of this invention was installed in a 2004 Ford F-150 pickup truck. One Advanced DC FB 1-4009 motor was mounted rigidly on angle iron cross members running between the frame rails of the truck. The drive was a combination of the concepts shown in FIGS. 3 b and 4 a,b. The driven Poly Chain sprocket was 7.1 inches in diameter and was mounted on the front universal joint of the two-part drive shaft. It was driven by two 1 meter long 125 tooth×8 mm pitch Poly Chains.

The 3.2-inch drive sprockets were mounted on pillow block bearings and driven by a separate 180 tooth Poly Chain as shown in FIGS. 4 a,b. the electric motor was coupled to the inter-sprocket drive through a flexible coupling rather than a clutch 58.

The motor was powered by 12 Trojan 1275 flooded lead acid batteries and 4 Valence U24-12XP batteries in series through a Curtis 1231-8600 controller modified to accept 200 V DC. The batteries were recharged by a Zivan NG-3 charger for the lead acid pack and a Zivan NG-1 for the lithium ion pack. The truck has operated successfully after conversion both with and without electric assist. Vibration is negligible and the noise with electric propulsion is that expected with a Poly Chain drive. There is no evidence of wear or leakage from the after transmission bushing and seal. The truck had a fuel mileage of 17.5 miles per gallon prior to conversion. After conversion it has been measured as 38 mpg with electric assist, a more than 50% reduction in fuel consumption.

It will be understood by those skilled in the art that various combinations of the methods disclosed herein are possible and the citation of specific embodiments is not intended to preclude coverage of other possible variants of the basic ideas claimed herewith.

I claim:

1. A force-balanced, flexible drive in which a driven pulley or sprocket is subjected to a pure torque, while allowing limited motion in both radial directions to accommodate vibration and relative motion between the driven shaft and the fixed surroundings, by one or more belts or chains with loops on opposite sides of the driven pulley or sprocket member, in which each loop is driven by a driving means fixed to the surroundings, each driving means having a driving pulley or sprocket which exerts forces on its loop which are equal and opposite to the forces exerted by the opposite driving pulley or sprocket, resulting in a pure torque being applied to the driven pulley or sprocket member, and in which the loops are tensioned by moveable tensioning means of minimum mass to improve dynamic response at high vibration frequencies and thereby reduce stress on the drive.

2. The drive in claim 1 in which the tensioning means are mounted on opposite sides of the belt or chain on light weight arms which can exert symmetric forces on the driven member and which arms are tensioned by interlinked noncompliant means chosen from the group: hydraulic cylinders, cables, chains, rods and links.

3. The drive in claim 1 in which the belt is chosen from the group: V belt, multigroove J belt, cogged belt and timing belt.

4. The drive in claim 1 in which the chain is chosen from the group: single strand roller chain, multiple strand roller chain, Poly Chain, internal tooth silent chain and timing chain.

5. The drive in claim 1 in which the moveable tensioning means are chosen from the group: pulleys, sprockets, rollers or low friction blocks.

6. The drive in claim 1 in which the driving means are chosen from the group: DC electric motors, AC electric motors, hydraulic motors, pneumatic (compressed air driven) motors, steam engines and turbines, and internal combustion engines, including reciprocating and turbine engines.

7. The drive in claim 1 in which the driving means are located remotely and drive the driving pulleys or sprockets via flexible drive means chosen from the group: shafting, belts, chains or combinations of these.

8. The drive in claim 1 in which each of the driving pulleys or sprockets is connected to the driving means via clutch means which are chosen from the group: roller ramp clutch, cam clutch, ball clutch, electrically operated clutch, hydraulically operated clutch and mechanically operated clutch.

9. The drive in claim 1 in which a single driving means is used to provide torque through a gear box, belt drive or chain drive to two driving pulleys or sprockets, which are used to provide balanced tension.

10. The drive in claim 9 in which a belt or chain drive is used to connect the two driving pulleys to the driving means chosen from the group: single strand roller chain, multiple strand roller chain, Poly Chain, internal tooth silent chain timing chain, V belt, multiple V belt, multigroove J belt and timing belt, and in which the belt or chain is tensioned by moving one of the driving assemblies.

11. The drive in claim 9 in which a belt or chain drive is used to connect the two driving pulleys to the driving means chosen from the group: single strand roller chain, multiple strand roller chain, Poly Chain, internal tooth silent chain timing chain, V belt, multiple V belt, multigroove J belt and timing belt, and in which the belt or chain is tensioned by one or more moveable blocks, pulleys, sprockets or rollers.

12. The drive in claim 9 in which the driving means is coupled to the gearbox or chain drive by a clutch means chosen from the group: roller ramp clutch, cam clutch, ball clutch, electrically operated clutch, hydraulically operated clutch and mechanically operated clutch.

13. The drive in claim 9 in which the driving means are chosen from the group: DC electric motors, AC electric motors, hydraulic motors, pneumatic (compressed air driven) motors, steam engines and turbines, and internal combustion engines, including reciprocating and turbine engines.

14. The drive in claim 9 in which the driving means are located remotely and drive the driving pulleys or sprockets via flexible drive means chosen from the group: shafting, belts, chains or combinations of these.

15. The drive in claim 1 installed in a motor vehicle to provide additional torque on a drive shaft of the motor vehicle enabling its operation as a parallel hybrid vehicle while maintaining limited radial movement of the shaft relative to the chassis of the vehicle without imposing excessive radial loads.

16. The drive in claim 1 applied to rear wheel drive vehicles in which the drive is applied to the forward yoke of a universal joint of a single or multi-part drive shaft allowing electric motors to drive the rear wheels of the vehicle in conjunction with the IC engine or by alternative energy alone.

17. The drive in claim 1 applied to the front, relatively immobile, section of a multi-part drive shaft assembly at any convenient location

18. The drive in claim 1 applied to four-wheel drive vehicles in which the drive is applied to one of the drive shafts, allowing driving means to provide power to drive the front and/or rear wheels of the vehicle in conjunction with the IC engine or by alternative energy alone.

19. The drive in claim 1 as a conversion package or kit comprising the parts necessary to convert a particular vehicle from an internal combustion vehicle to an IC-electric hybrid vehicle, these parts comprising principally one or more electric motors and the force-balanced, flexible drive of claim 1, so that mechanics skilled in automotive repair can perform the conversion.

20. A vehicle converted from an internal combustion vehicle to an IC-electric hybrid vehicle, either as a new vehicle or a previously used vehicle, having the essential components of one or more electric motors and the flexible, force-balanced drive of claim 1 to provide a pure torque to the vehicle drive shaft while allowing limited vibration and movement of the shaft relative to the vehicle chassis.
